(19) United States
(12) Patent Application Publication
(10) Pub. No.: US 2012/0085724 A1
(43) Pub. Date: Apr. 12, 2012

(54) INSULATED REUSABLE SELF-WARMING BEVERAGE AND FOOD CONTAINER

(76) Inventor: Jeremy George Barker, Morgan, UT (US)

(21) Appl. No.: 12/900,475

(22) Filed: Oct. 8, 2010

(51) Int. Cl. A61J 9/02; F24J 1/00

(52) U.S. Cl. 215/11.2; 126/263.01

(57) ABSTRACT

The present invention generally relates to insulated reusable mugs, bottles, food containers, and beverage containers. The present invention teaches a self-heating, sealed beverage container insulated with a supersaturated solution and an activator actuated by a button mechanism on the beverage container; which, when depressed, triggers an exothermic crystallization process that heats a beverage contained within the beverage container.

### BACKGROUND OF THE INVENTION

1. Field of the Invention

This invention relates to insulated beverage containers, and more particularly relates to improved to insulated reusable self-warming beverage and food containers.

2. Description of the Related Art

The present invention teaches improved reusable insulated beverage and food containers, including improved coffee mugs, baby bottles, and trays. Reusable insulated beverage containers are well-known in the art, and have been manufactured under a variety of trade names since the 1800s.

Traditional coffee mugs rely on insulation built into the cylinder walls of the mug to maintain the heat of a contained beverage usually preheated in an environment external to the mug or container itself. While traditional containers have been reusable and insulted, they have provided no means of heating or reheating the contained beverage, and, like all insulated containers, cannot prevent the beverage from losing heat with time. Advances in the art include a variety of coffee mugs of various designs which provide means of electronically heating the beverage in situ. These advances rely on direct current supplied by an automobile or disposable batteries, or on alternating current supplied by 110 V electrical wall sockets. The electrical components, wires, and weight of these containers have proved cumbersome and inconvenient to users of the containers, as has maintaining close proximity to a power supply, and none of the electrically powered beverage containers have proved to be commercially viable. Furthermore, the use and incorporation of high voltage electrical systems by the containers constitutes a perceived, if not actual, safety threat to users of the containers.

There exists no commercially viable, non-electrical self-heating reusable containers for heating, or reheating, a beverage, such as coffee, hot chocolate or milk.

### SUMMARY OF THE INVENTION

From the foregoing discussion, it should be apparent that a need exists for an insulated reusable self-warming beverage container. Beneficially, such a container would overcome many of the difficulties with prior art by providing a means of self-warming a beverage using non-cumbersome, non-electrical means.

The present invention has been developed in response to the present state of the art, and in particular, in response to the problems and needs in the art that have not yet been fully solved by currently available devices. Accordingly, the present invention has been developed to provide a reusable self-warming beverage container. The reusable self-warming beverage container comprises a cylindrically-shaped, impermeable inner shell comprising a planar underside, a sidewall, and an open top, with a longitudinal axis extending upwardly from a center of the underside through the open top, and with a lateral axis extending orthogonally from the longitudinal axis and outwardly from the underside, wherein the sidewall is radially disposed around the circumference of the underside and the longitudinal axis, wherein the sidewall and underside define a hollow recess within the inner shell for containing a beverage, the hollow recess accessible through the open top, encircled by the sidewall and underlaid by the underside.

The reusable self-warming beverage container further comprises a cylindrically-shaped, heat resistant, impermeable outer shell comprising a planar baseplate and an outer sidewall, wherein the outer sidewall and baseplate define a second recess within the outer shell for containing both a supersaturated solution and the inner shell, the outer sidewall radially disposed around the circumference of the baseplate, wherein the second recess is completely interiorly isolated from ambient air, the second recess being defined and encircled exteriorly by the outer sidewall, being interiorly defined by the inner shell, being defined and underlaid by the baseplate, being defined and enclosed upperly by an annular rim.

The reusable self-warming beverage container further comprises the annular rim, having an outer edge and an inner edge, the outer edge affixed throughout its circumference to the outer sidewall of the outer shell, the inner edge affixed throughout its circumference to the sidewall of the inner shell; as well as a supersaturated solution filling the second recess; and an activator set within the supersaturated solution, which activator causes the supersaturated solution to undergo exothermic crystallization when flexed.

The reusable self-warming beverage container additionally comprises a handle affixed to the outer shell, the handle comprising a push button which contacts the activator when depressed.

In some embodiments, the inner shell, outer shell, rim, handle of the reusable self-warming beverage container are heat resistant to temperatures greater than 105 degrees Celsius.

In other embodiments, the reusable self-warming beverage container comprises a further comprises a push rod disposed between the push button and the activator, which push rod flexes the activator when the push button is depressed.

The reusable self-warming beverage container may further comprise an annular heat-resistant gasket disposed within an aperature in the outer shell, through which the push rod extends, which gasket prevents seepage of the supersaturated solution outside the outer shell.

In still further embodiments, the reusable self-warming beverage container further comprises a teat covering the open top and detachably connected to the annular rim, from which a baby can suck a beverage contained in the hollow recess.

The reusable self-warming beverage container may further comprise a teat covering the open top and detachably connected to the annular rim, from which a baby can suck a beverage contained in the hollow recess.

In some embodiments, the reusable self-warming beverage container further comprises a thermometer affixed to the outer shell. The activator may comprise a flexible steel disk and an electronically activated boiler.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1A is an upper isometric perspective view of an insulated reusable self-warming coffee mug in accordance with the present invention;

FIG. 1B is a top perspective view of an insulated reusable self-warming coffee mug in accordance with the present invention;

FIG. 2A is a side perspective view of an insulated reusable self-warming baby bottle in accordance with the present invention;

FIG. 2B is a cross-sectional perspective view of an insulated reusable self-warming baby bottle in accordance with the present invention;

FIG. 2C is a top perspective view of an insulated reusable self-warming baby bottle in accordance with the present invention; and

FIG. 2D is a side perspective view of an insulated reusable self-warming beverage container in accordance with the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

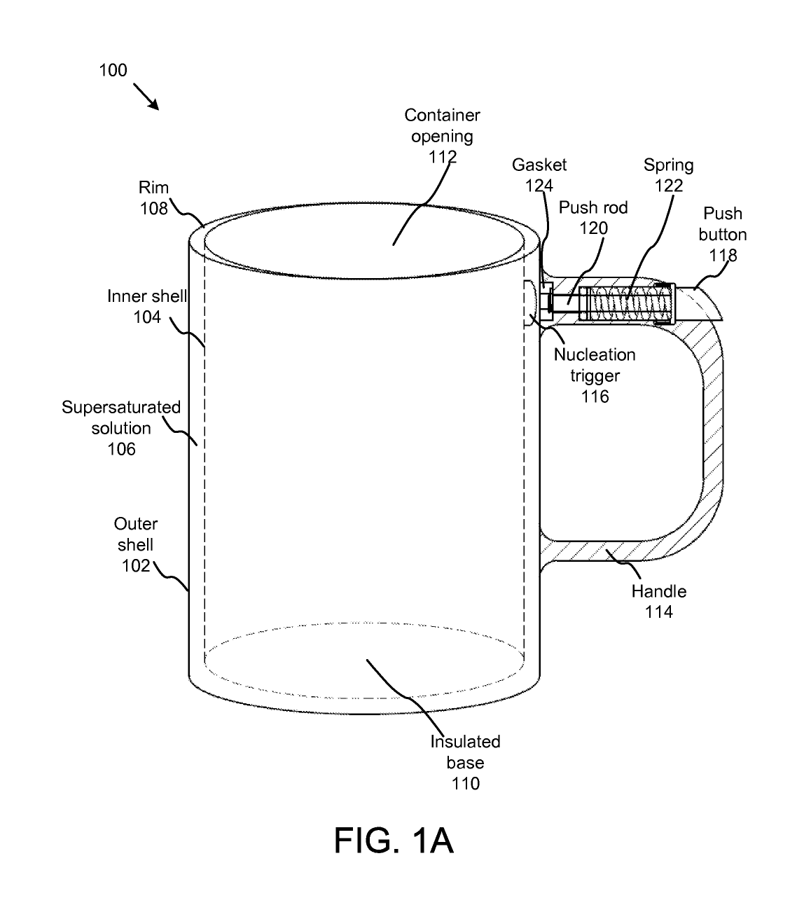

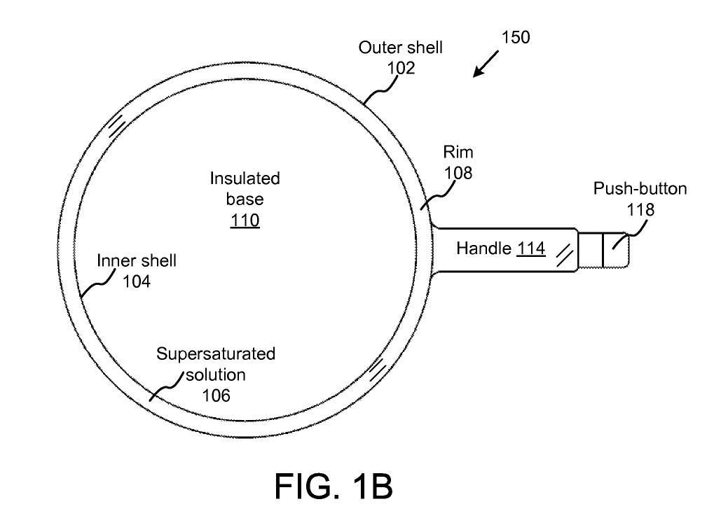

FIG. 1A is an upper isometric perspective view of an insulated reusable self-warming coffee mug 100 in accordance with the present invention. The insulated reusable self-warming coffee mug 100 comprises an outer shell 102, an inner shell 104, a supersaturated solution 106, a rim 108, an insulated base 110, a container opening 112, a handle 114, a nucleation trigger 116, a push button 118, a push rod 120, a spring 122, and a gasket 124.

The outer shell 102 comprises an elongated, heat-resistant, cylindrically-shaped, water impermeable, container manufactured from any of a variety of materials well-known to those of skill in the art, including metals, alloys, stainless steel, and polymers. The outer shell 102 receives the inner shell 104 and a supersaturated solution 114, which fills and insulates a volume between the outer shell 102 and the inner shell 104.

The outer shell 102 is defined by a sidewall, an insulated base 110, a rim 108 and an open top. In some embodiments, the outer shell 102 comprises a neck. The sidewall comprises a surrounding edge, which encircles the longitudinal axis of the mug 100 and is in abutmet with the insulated base 110. The longitudinal axis 100 runs from the center of the insulated base 110 through the center of the top opening (or container opening 112). The lateral axis runs laterally from the center of the insulated base 110 to the outer edge of the insulated base 110 where the insulated base 110 meets the sidewall.

The rim 108 defines an annularity which is the top opening or container opening 112. Coffee, or other liquids needing to be heated, are received by the mug 100 through the container opening 112.

The inner shell 104 comprises an elongated, cylindrically-shaped, water-impermeable, container manufactured from any of a variety of materials well-known to those of skill in the art, including metals, alloys, stainless steel, and polymers. The inner shell 104 is received by the outer shell 102, and necessarily comprises smaller dimensions than the outer shell 102 such that the inner shell 104 fits within the outer shell 102.

The inner shell 104 is defined by a sidewall, a base, and an open top. In some embodiments, the inner shell 104 comprises a neck. The sidewall comprises a surrounding edge, which encircles the longitudinal axis of the mug 100 in abutment with the base.

The supersaturated solution 106 comprises any solution that contains more dissolved material than could normally be dissolved into the solution at room temperature. In the prime embodiment, the supersaturated solution 106 comprises sodium acetate, which produces heat through exothermic crystallization, which crystallization is initiated by nucleation center(s) created by manually manipulating a rigid device in the supersaturated solution 106 such a metal disk.

In other embodiments, the supersaturated solution 106 additionally or alternatively comprises other solutions which produce exothermic reactions when exposed to air, including iron, vermiculite, salt, and/or cellulose.

The mug 100 comprises a handle 114, which is well-known to those of skill in the art. The handle 114 is affixed to the exterior of the outer shell 102, and is meant to provide a grip to a human being making use of the mug. The handle 114, in the preferred embodiment, comprises a heat-resistant material to keep a user's hand(s) from burning when holding a heated mug 100.

The handle 114, in the shown embodiment, comprises a push button 118 which pushes a push rod 120 against a nucleation trigger 116. The nucleation trigger 116 comprises a rigid metal or alloy disk which can be flexed to create nucleation centers within the supersaturated solution 106.

The shown embodiment includes a spring 122 which resets the push button 118, and a gasket 124 which forms a liquid-proof seal around the push rod 120. The gasket 124 is nestled within a hole within the outer shell 102. In the shown embodiment, the push rod 120 slides through the gasket 124 and pushes against, or activates, the nucleation trigger 116. In other embodiments, the push rod 120 contacts an elastomeric, or flexible, portion of the outer shell 102, which is inserted into a hole cut into the outer shell 102.

In some embodiments, the push button 118 and its accompanying mechanical components, are affixed directly to the outer shell 102 instead of the handle 114.

In some embodiments of the present invention, the push button 118 injects air into the supersaturated solution 106 to produce an exothermic reaction. In some embodiments, the push button 118 forms part of a pump which injects ambient air into the supersaturated solution 106. In other embodiments, the push button 118 opens a valve and pneumatically injects stored air into the supersaturated solution 106 using means that are well-known to those of skill in the art.

In the some embodiments, the outer shell 102 comprises a drain plug for draining the supersaturated solution 106 from the mug 100 and/or reintroducing replacement supersaturated solution 106.

The inner shell 104 is smaller than the outer shell 102, in both diameter and height, so as to sit nestled within the outer shell 102 such that its edges are spaced apart from the inside edges of the outer shell 102.

In various embodiments of the present invention, the mug 100 may comprise a food holding container, for heating vegetables, meats, and other edibles. In various embodiments of the present invention, the mug 100 may be square instead of cylindrical, or be formed in the shape of any number of other flat-bottomed three-dimensional geometric shapes meant to accommodate food portions.

FIG. 1B is a top perspective view of an insulated reusable self-warming coffee mug 150 in accordance with the present invention. The insulated reusable self-warming coffee mug 150 comprises an outer shell 102, an inner shell 104, a supersaturated solution 106, a rim 108, an insulated base 110, a handle 114, and a push button 118.

The coffee mug 150 is shown looking straight down the longitudinal axis. The upper surface of the rim 108 is shown. The supersaturated solution 106 is encased within the mug 150, underneath the rim 108, above the insulated base 110, and between the inner shell 104 and the outer shell 102.

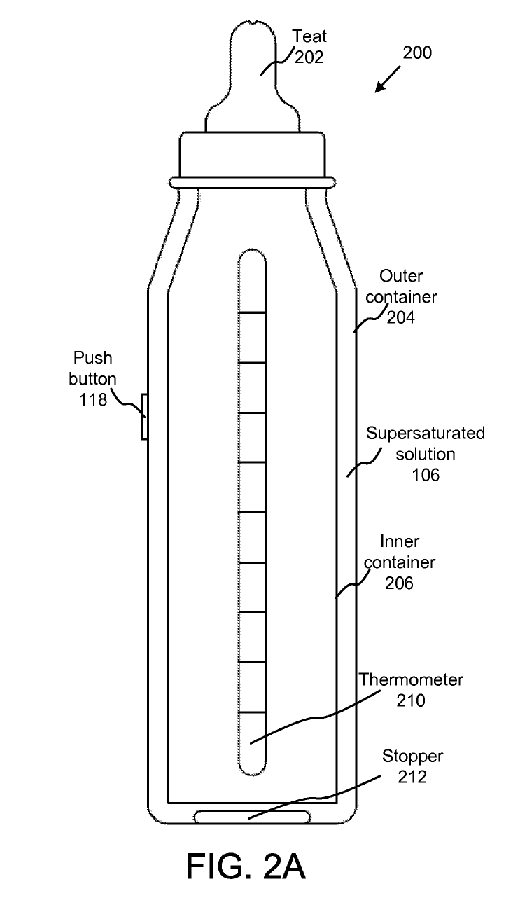

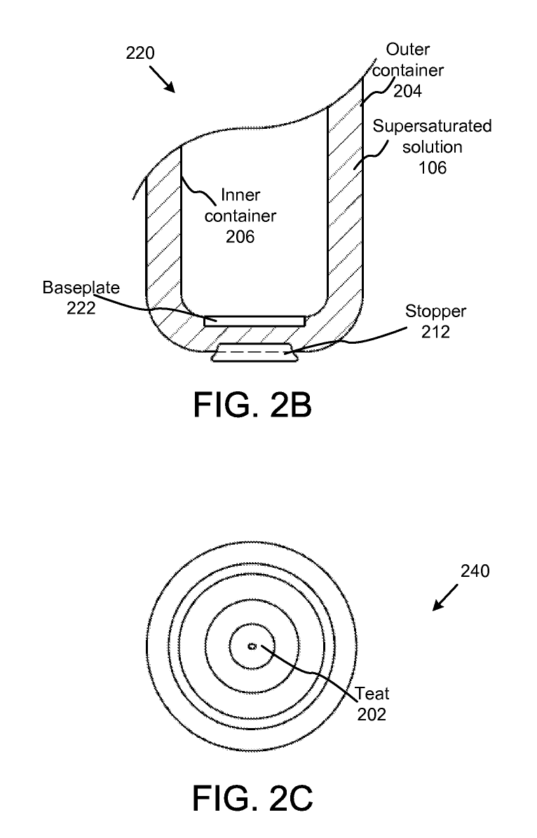

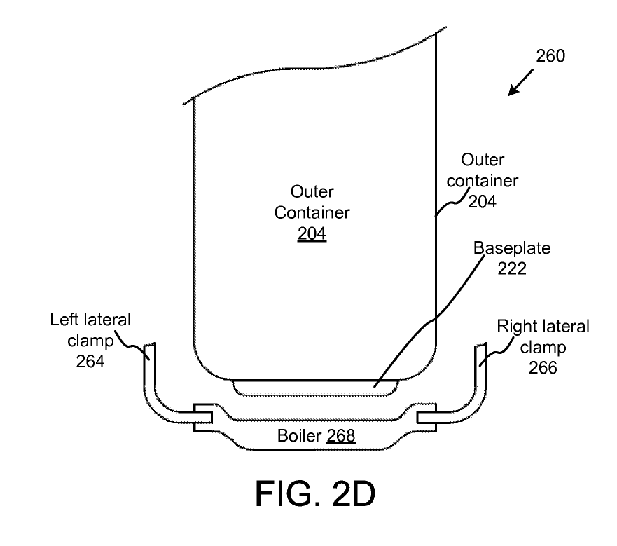

FIG. 2A is a side perspective view of an insulated reusable self-warming baby bottle 200 in accordance with the present invention. The insulated reusable self-warming baby bottle 200 comprises a supersaturated solution 106, a push button 118, a teat 202, an outer container 204, an inner container 206, a thermometer 210, and a stopper 202.

The bottle 200 comprises the same functional elements as the mugs 100, 150.

The outer contain 204 is substantially similar to the outer shell 102 and the inner container 102 is substantially similar to the inner shell 104. The bottle 200 is bottle-shaped, and meant to heat milk, baby-food and other substances for infants and toddlers.

The teat 202 is well-known to those of skill in the art.

The bottle 200 comprises a thermometer 210 affixed in or on the outer container 204, or within the inner container 206.

FIG. 2B is a cross-sectional perspective view of an insulated reusable self-warming baby bottle 220 in accordance with the present invention. The insulated reusable self-warming baby bottle 220 comprises a supersaturated solution 106, an outer container 204, an inner container 206, a baseplate 222, and a stopper 202.

The supersaturated solution 106, the outer container 204, and the inner container 206 are substantially described above in relation to FIG. 2A.

The baseplate 222, in the shown embodiment, comprises an alloy or metal plate affixed within, resorbed into, or affixed inside of, or outside of, the inner container 206. In some embodiments of the present invention, the baseplate 222 comprises electrical means for heating the contents of the bottle 220 and/or the supersaturated solution 106. By heating the supersaturated solution 106 after an exothermic reaction, the material dissolved into the supersaturated solution 106 becomes reabsorbed, and the heating mechanism and bottle 220 are reset for repeated use.

FIG. 2C is a top perspective view of an insulated reusable self-warming baby bottle 240 in accordance with the present invention. The insulated reusable self-warming baby bottle 240 comprises a teat 202.

The teat 202 is substantially described above in relation to FIGS. 2A-2B.

FIG. 2D is a side perspective view of an insulated reusable self-warming beverage container 260 in accordance with the present invention. The insulated reusable self-warming baby bottle 260 comprises an outer container 204, a baseplate 222, a left lateral clamp 264, a right lateral clamp 266, and a boiler 268.

The outer container 204, and the baseplate 222 are substantially described above in relation to FIGS. 2A-2C.

In the shown embodiment, the left lateral clamp 264 and the right lateral clamp 266 comprise rigid arms, affixed to the boiler 268, which clamp onto the bottle 260. The left lateral clamp 264, the right lateral clamp 266, and the boiler 268 collectively comprise a clamp. In various embodiments of the present invention, the clamp comprises a plurality of lateral clamps for attaching the clamp detachably to the bottle 260. In various embodiments of the present invention, the boiler 268 clamps onto the bottle 260 using any number of means well-known to those of skill in the art, including buckles, snaps, Velcro®, straps, ties, and the like. In some embodiments of the present invention, the bottle 260 slides into the boiler 268. In other embodiments, the bottle 260 rests within the boiler 268. In still further embodiments, the bottle 260 lacks the baseplate 222, which transfers heat to the supersaturated solution 106 in the shown embodiment.

The boiler 268, in some embodiments of the present invention, is electronically activated by alternating or direct electrical current supplied by a power source, such as a wall socket, car battery, and the like. In some embodiments, the boiler 268 is powered by a computer USB port.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A reusable self-warming beverage container, the reusable self-warming beverage container comprising:
a cylindrically-shaped, impermeable inner shell comprising a planar underside, a sidewall, and an open top, with a longitudinal axis extending upwardly from a center of the underside through the open top, and with a lateral axis extending orthogonally from the longitudinal axis and outwardly from the underside, wherein the sidewall is radially disposed around the circumference of the underside and the longitudinal axis, wherein the sidewall and underside define a hollow recess within the inner shell for containing a beverage, the hollow recess accessible through the open top, encircled by the sidewall and underlaid by the underside;
a cylindrically-shaped, heat resistant, impermeable outer shell comprising a planar baseplate and an outer sidewall, wherein the outer sidewall and baseplate define a second recess within the outer shell for containing both a supersaturated solution and the inner shell, the outer sidewall radially disposed around the circumference of the baseplate, wherein the second recess is completely interiorly isolated from ambient air, the second recess being defined and encircled exteriorly by the outer sidewall, being interiorly defined by the inner shell, being defined and underlaid by the baseplate, being defined and enclosed upperly by an annular rim;
the annular rim, having an outer edge and an inner edge, the outer edge affixed throughout its circumference to the outer sidewall of the outer shell, the inner edge affixed throughout its circumference to the sidewall of the inner shell;
a supersaturated solution filling the second recess;
an activator set within the supersaturated solution, which activator creates nucleation centers and causes the supersaturated solution to undergo exothermic crystallization when flexed; and
a handle affixed to the outer shell, the handle comprising a push button which contacts the activator when depressed.

2. The reusable self-warming beverage container of claim 1, wherein the inner shell, outer shell, rim, and handle are heat resistant to temperatures greater than 105 degrees Celsius.

3. The reusable self-warming beverage container of claim 1, further comprising a push rod disposed between the push button and the activator, which push rod flexes the activator when the push button is depressed.

4. The reusable self-warming beverage container of claim 3, further comprising an annular heat-resistant gasket disposed within an aperature in the outer shell, through which the push rod extends, which gasket prevents seepage of the supersaturated solution outside the outer shell.

5. The reusable self-warming beverage container of claim 1, further comprising a teat covering the open top and detachably connected to the annular rim, from which a baby can suck a beverage contained in the hollow recess.

6. The reusable self-warming beverage container of claim 1, further comprising a teat covering the open top and detachably connected to the annular rim, from which a baby can suck a beverage contained in the hollow recess.

7. The reusable self-warming beverage container of claim 1, further comprising a thermometer affixed to the outer shell.

8. The reusable self-warming beverage container of claim 1, wherein the supersaturated solution comprises sodium acetate.

9. The reusable self-warming beverage container of claim 1, wherein the activator comprises a flexible steel disk.

10. The reusable self-warming beverage container of claim 1, further comprising a detachable electronic boiler affixed to outer shell, which boiler heats the supersaturated solution after initiation of the exothermic reaction to re-saturate the solution.
